(19) United States
(12) Patent Application Publication
(10) Pub. No.: US 2004/0189093 A1
(43) Pub. Date: Sep. 30, 2004

(54) Window regulator control switch

(76) Inventor: Jean-Marc Belmond, St. Jean Le Blanc (FR)

Correspondence Address: CARLSON, GASKEY & OLDS, P.C., 400 WEST MAPLE ROAD, SUITE 350, BIRMINGHAM, MI, 48009, US

(21) Appl. No.: 10/798,221

(22) Filed: Mar. 11, 2004

(30) Foreign Application Priority Data
Mar. 18, 2003 (FR) 03 03 298

(51) Int. Cl. B60L 1/00

(52) U.S. Cl. 307/10.1

(57) ABSTRACT

A window regulator control switch includes a rear view mirror selector adjustable in left and right positions to adjust the rear view mirrors. A control button enables or disables a rear door function, such as a child safety function or the locking of a local window regulator. The control button enables or disables the rear door function for the left-hand or right-hand rear door depending on the position of the selector. The selector also has a neutral position in which action on the control button enables or disables the rear door function for the rear doors. The switch allows for flexibility of the controls without proportionally increasing the number of buttons.

This application claims priority to French Patent Application FR 03 03 298 filed on Mar. 18, 2003.

### TECHNICAL FIELD

The invention relates generally to switches for motor vehicles and more particularly to switches designed to control window regulators in motor vehicles.

### BACKGROUND OF THE INVENTION

Motor vehicles are often equipped with electric window regulators including an electric motor and a kinematic linkage that converts the rotation of the motor shaft into translation of the associated window. By using a switch, the user can control the operation of the motor in one direction or the other to raise or lower the window. The switch has one or more buttons that can be activated by the user to control the window. Various technologies can be utilized, such as on switches, pushbuttons, capacitive controls or others. The switch is also referred to as the window regulator control switch or as the power window control switch.

FIG. 1 illustrates a diagram of the controls on the driver's door of Renault's Laguna model vehicle. A control knob 2 is provided to remotely control the position of the rear view mirrors. The control knob 2 is rotatably adjustable to four positions about an approximately vertical axis. The reference numerals 4, 6, 8 and 10 denote the four positions, with the control knob 2 illustrated in the neutral position. The front position 10 is the neutral position in which the control knob 2 is not active. The right position 6 allows the right-hand rear view mirror to be adjusted, and the left position 8 allows the left-hand rear view mirror to be adjusted. The rear position 4 allows the rear view mirrors to be folded in along the vehicle when stopped. The control knob 2 can be moved forwards or backwards for up-down adjustment of the right-hand or left-hand rear view mirror in the right or left position. The control knob 2 can be moved to the left or right for a left or right adjustment of the left-hand or right-hand rear view mirror in the left or right position.

Window control buttons 12, 14, 16 and 18 are also mounted on the driver's door to control the front driver's window, the front passenger's window, the left-hand rear window and the right-hand rear window, respectively. Each button 12, 14, 16 and 18 can be activated by forward or backward pressure to control the raising or lowering of the corresponding window.

A switch on each of the front passenger, the left-hand rear, and the right-hand rear doors controls the corresponding window with a single button. A locking button 20 on the front driver's door can be used to disable the operation of the switches on the rear doors to prevent the rear windows from being activated by children.

The Nissan Terrano includes a knob on the instrument panel with three positions (neutral, left and right) and a cross-shaped button. The cross-shaped button is used for the for the up-down or left-right adjustment of the rear view mirror selected with the three-position knob.

The many functions lead to numerous controls on the driver's door or instrument panel. This creates a problem of control ergonomics because the controls are activated blindly by the driver while driving. It also creates a problem of construction as the number of controls and the wires connecting the controls are increased.

FR-A-2 828 707 discloses a control system for electric windows in motor vehicles.

These vehicles can also have a child safety function. When activated, the child safety function prevents action on an interior rear door control from opening the corresponding door. The child safety function is arranged on the end panel of the corresponding door and is accessible only when the door is open. Therefore, the vehicle must be stopped to disable or enable the child safety function. Application US2001/0004044 scribes the controlling the child safety function using a central knob.

Thus, there is a need for a switch for a window regulator control that fully or partly solves one or more of these problems.

### SUMMARY OF THE INVENTION

The present invention provides a window regulator control switch including a rear view mirror selector having at least three positions and a control button to enable or disable a first rear door function.

The control button is designed to enable or disable the first rear door function of one or both of the rear doors depending on the position of a rear view mirror selector. The selector also controls the position of the rear view mirror.

The switch can also include a second control button to enable or disable a second rear door function depending on the position of the selector.

One of the rear door functions is a child safety function. When enabled, the child safety function prevents the door lock from opening by action on the interior door control. Another rear door function disables a window regulator or a local window regulator control.

In one position of the selector, the control button enables or disables at lest one of the rear door functions on one of two rear doors. In one position of the rear view mirror selector, the control button enables or disables at least one of the rear door functions on both rear the doors.

Other characteristics and advantages of the invention will become apparent on reading the description that follows, which is given as an example and in reference to the drawings.

### BRIEF DESCRIPTION OF THE DRAWINGS

FIG. 1 is a schematic view of the controls of a state-of-the-art vehicle;

FIG. 2 is a schematic block view of a switch according to the present invention; and

FIG. 3 is a schematic view of the electric circuit of the switch in FIG. 2.

### DETAILED DESCRIPTION OF THE PREFERRED EMBODIMENT

In the window regulator control switch of the present invention, the window regulator controlled by action on a button depends on the position of the rear view mirror selector. A single button can control several window regulators, simplifying the switch by reducing the number of buttons and connecting wires. From an ergonomic point of view, the user can more easily identify the buttons due to the reduced number of buttons. It remains highly intuitive for the user, due to the known operation of the rear view mirror control knob, to control one or more of the rear view mirrors. In one embodiment, the driver can control the child safety function without increasing the number of buttons.

In the description that follows, the words vertical, horizontal, left, right, up and down are used in reference to the position in the vehicle. The embodiment of the invention is described in a standard installation on a driver's door situated on the left. However, the switch could be arranged in other positions.

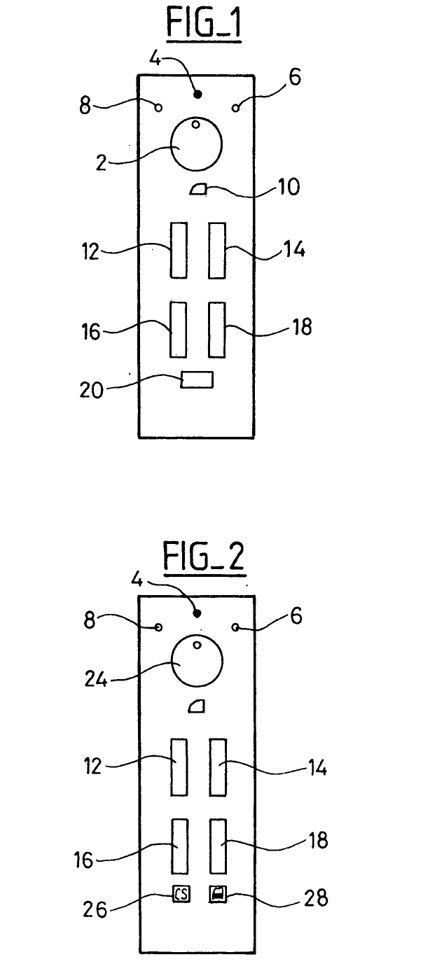

FIG. 2 illustrates a schematic block view of the switch according to one embodiment of the present invention. The switch includes a rear view mirror selector 24 having the same shape as the control knob 2 of FIG. 1 and is used to both select and control the position of the rear view mirrors. However, the invention could be implemented with a selector 24 that only selects the rear view mirror, as in the case of the Nissan Terrano vehicle described above. The selector 24 has at least two positions corresponding to the right-hand and left-hand rear view mirrors.

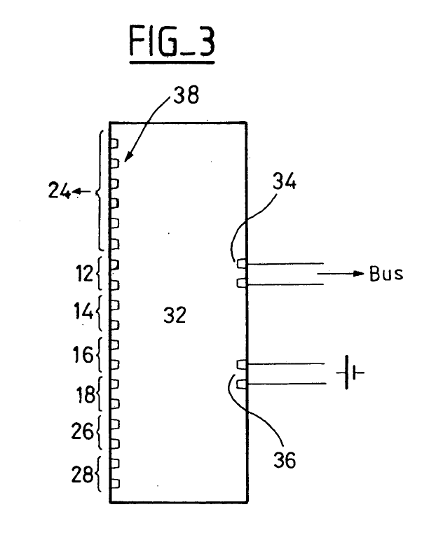

In addition to the selector 24, the switch also has at least one control button to enable or disable a door function. The switch has a first button 26 to control a child safety function, marked in the diagram with the abbreviation “CS”, that stands for “child safety.” The switch has a second button 28 to control a local window regulator enable or disable function. Each control button 26, 28 enables or disables the corresponding function, depending on its position or activation by the user, on one or more doors depending on the position of the selector 24. As explained in reference to FIG. 3, the switch is designed to generate, depending on the position or the activation of a button, a control signal for the corresponding door function intended for one of the doors depending on the position of the selector 24.

The selector 24 has three usable positions (left, right and neutral) in addition to a position for folding in the rear view mirror. When the selector 24 is in the neutral position shown in FIG. 2, action on the first button 26 disables or enables the child safety function on the two rear doors. Action on the second button 28 disables or enables the local window regulator control on the two rear doors. When the selector 24 is in the left (or right) position, action on the first button 26 or the second button 28 disables or enables the corresponding function on the rear left-hand (or right-hand) door.

The switch allows for the control of the states of the rear doors by the two buttons 26, 28 and the selector 24. The switch in FIG. 2 offers additional functions over the switch of FIG. 1. Even if the switch in FIG. 2 has only a single button for disabling the window regulator, the switch allows the function in question to be disabled or enabled separately for the two rear doors.

In FIG. 2, the switch, like the switch in FIG. 1, has four buttons 16, 18, 20, 22 to control the window regulators on the four doors. The principle of the invention can also be applied to these buttons 16, 18, 20 and 22. It would thus be possible to provide only two control buttons, such as two buttons situated one behind the other in the front-rear direction. For one position of the selector 24, such as the left position of the selector 24, the front button then controls the front driver's door window regulator and the rear button controls the window regulator on the left-hand rear door. When the selector 24 is in the neutral position, the front button controls the window regulators on the two front doors and the rear button controls the window regulators of the two rear doors. When the selector 24 is in the right position, the front button controls the window regulator on the right-hand passenger door and the rear button controls the window regulator on the right-hand rear door. This configuration has the advantage of similarity with controls for the buttons 26, 28, making learning easier. However, when the selector 24 is in the neutral position, which is the normal position after adjustment of the rear view mirrors, action on the control buttons causes the opening or closing of the two windows. It is also possible that in the neutral position, the front and rear control buttons control the left-hand window regulators. The invention makes it possible to provide more functions than the switch of FIG. 1 with a reduced number of buttons.

FIG. 3 schematically illustrates the electric circuit of the switch of FIG. 2. The circuit essentially includes a component 32, which in the example is integrated. The component 32 includes two terminals 34 for connection to a multiplexed bus in the vehicle, such as a CAN bus or a JS1850 bus (US). The component 32 also has two terminals 36 for supply by the vehicle's main electric circuit. The circuit also has two terminals 38 for connection to the selector 24 and to the different buttons on the switch. In the example, two terminals determine the four positions of the selector 24 and four terminals receive the rear view mirror adjustment instructions. Each of the buttons 12, 14, 16, 18, 26 and 28 is connected to the circuit 32 by two wires. This structure corresponds to the example of buttons having one idle state and two states as a function of pressure by the user on one or other side of the button.

The circuit determines the position of the selector 24 via signals present on the corresponding terminals on receiving a change-of-state signal on the terminals connected to a function button 26 or 28. Depending on the button activated and the position of the selector 24, it issues a signal on the multiplexed bus to the door or doors concerned. The signal represents the enabling or disabling of the function in question.

The example in FIG. 3 corresponds to a particular type of button. It would also be possible to implement the invention with other buttons. For example, the buttons 26 and 28 can only have one stable idle state and one state activated by action by the user. This can easily be achieved by capacitive sensor buttons or by switches depressed under the action of the user's finger that then return to their initial position. The user selects the door or doors using the selector 24, then activates one of the function buttons to change the state, enabled or disabled, of the corresponding function on the corresponding door. An indicator can be provided to show the state of the function. The state of the indicator represents the state of the function in question for the door or doors corresponding to the position of the selector 24. A double indicator can also be provided to indicate four states for each button. The indicator gives information that does not depend on the position of the selector 24. The indicator can be implemented using one or two diodes or by a liquid crystal display with one or two cells. The indicator allows the user to easily note whether the functions are enabled or disabled, if appropriate, depending on the position of the selector 24.

The invention is not limited to the embodiments described as examples. In particular, the shapes of the selector 24 and of the button(s) can vary. In FIG. 2, the function controlled by the button 28 disables a local window regulator control. It would also be possible to control a function to completely disable the window regulator, also preventing its control from the driver's door. In the example, two control buttons were considered, the effect of which depends on the position of the selector 24. However, it is possible to provide only one button if desired. The example has also been given of a neutral position controlling the two rear doors. It could also be envisioned that this position controls the front passenger door, and the selector 24 could also have a fourth position.

In FIG. 2, the switch has a configuration designed for mounting on the driver's door. It would also be possible to use a configuration designed for mounting on an instrument panel.

In FIG. 3, the example of an indicator is given for one type of button. However, an indicator can also be used for the other types of buttons.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A window regulator control switch comprising:
a rear view mirror selector to control a position of a rear view mirror and having at least three positions; and
a first control button to enable and disable a first rear door function based on a position of the rear view mirror selector.

2. The switch according to claim 1, further comprising a second control button to enable and disable a second rear door function based on the position of the rear view mirror selector.

3. The switch according to claim 1, wherein the first rear door function is a child safety function that prevents a door lock of an associated rear door from opening when enabled.

4. The switch according to claim 2, wherein the second rear door function is a window disabling function that prevents a window regulator of an associated rear door from operating when enabled.

5. The switch according to claim 1, wherein the first rear door function is a window disabling function that prevents a window regulator of an associated rear door from operating when enabled.

6. The switch according to claim 2, wherein the second rear door function is a child safety function that prevents a door lock of an associated rear door from opening when enabled.

7. The switch according claim 1, wherein the first control button enables and disables the first rear door function on a first rear door when the rear view mirror selector is in a first position.

8. The switch according to claim 1, wherein the first control button enables and disables the first rear door function on a first rear door and a second rear door when the rear view mirror selector is in a first position.

9. The switch according to claim 2, wherein the second control button enables and disables the second rear door function on a first rear door when the rear view mirror selector is in a first position.

10. The switch according to claim 2, wherein the second control button enables and disables the second rear door function on a first rear door and a second rear door when the rear view mirror selector is in a first position.

11. The switch according to claim 4, wherein the first rear door function is a child safety function, and enabling the child safety function prevents a door lock of an associated rear door from opening when enabled.

12. The switch according to claim 7, wherein the first control button enables and disables the first rear door function on the second rear door when the rear view mirror selector is in a second position.

13. The switch according to claim 12, wherein the first control button enables and disables the first door function on the first rear door and the second rear door when the rear view mirror selector is in a third position.

14. A window regulator control switch comprising:
a rear view mirror selector to control a position of a rear view mirror and having at least three positions;
a first control button to enable and disable a child safety function that prevents a door lock of an associated rear door from opening when enabled, and the child safety function is based on a position of the rear view mirror selector; and
a second control button to enable and disable a window disabling function that prevents a window regulator of the associated rear door from operating when enabled, and the window disabling function is based on the position of the rear view mirror selector.

15. The switch according claim 14, wherein the first control button enables and disables the child safety function on a first rear door when the rear view mirror selector is in a first position, enables and disables the child safety function on a second rear door when the rear view mirror selector is in a first position, and enables and disables the child safety function on the first rear door and the second rear door when the rear view mirror selector is in a third position.

16. The switch according claim 14, wherein the second control button enables and disables the window disabling function on a first rear door when the rear view mirror selector is in a first position, enables and disables the window disabling function on a second rear door when the rear view mirror selector is in a first position, and enables and disables the window disabling function on the first rear door and the second rear door when the rear view mirror selector is in a third position.
